(19) United States
(12) Patent Application Publication
(10) Pub. No.: US 2025/0206670 A1
(43) Pub. Date: Jun. 26, 2025

(54) NICKEL-MAGNESIUM-ZINC-COPPER FERRITE AND PREPARATION METHOD THEREFOR AND MAGNETIC DEVICE THEREOF

(71) Applicant: HENGDIAN GROUP DMEGC MAGNETICS CO., LTD., Jinhua (CN)

(72) Inventors: Yumei JIANG, Jinhua (CN); Guoyou ZHENG, Jinhua (CN); Xiaoli ZHU, Jinhua (CN)

(21) Appl. No.: 19/075,825

(22) Filed: Mar. 11, 2025

Related U.S. Application Data
(63) Continuation of application No. PCT/CN2023/122533, filed on Sep. 28, 2023.

(30) Foreign Application Priority Data
Dec. 13, 2022 (CN) 202211594105.5

(51) Int. Cl. C04B 35/26; C04B 35/626; C04B 35/64

(52) U.S. Cl. CPC C04B 35/265; C04B 35/62655; C04B 35/64; C04B 2235/3206; C04B 2235/3262; C04B 2235/3274; C04B 2235/3281; C04B 2235/3284; C04B 2235/606; C04B 2235/785; C04B 2235/786

(57) ABSTRACT

A nickel-magnesium-zinc-copper ferrite, a preparation method therefor and a magnetic device thereof are provided. The nickel-magnesium-zinc-copper ferrite includes major components, the major components include, by mass fraction, 66.95% to 71.8% of Fe₂O₃, 15.6% to 19.7% of ZnO, 2.1% to 4.2% of NiO, 2.1% to 5.0% of MnO, 2.0% to 4.9% of CuO and 1.82% to 2.98% of MgO; and auxiliary additives including CaCO₃, Bi₂O₃, MoO₃ and Co₂O₃. The preparation method includes weighing the major components according to proportion and wet-grinding same to obtain a first mixture; drying and pre-sintering the first mixture to obtain a pre-sintered material; weighing the auxiliary additives according to proportion, wet-grinding the auxiliary additives with the pre-sintered material and drying same to obtain a second mixture; and, powdering, shaping, and sintering the second mixture in sequence to obtain the nickel-magnesium-zinc-copper ferrite. The nickel-magnesium-zinc-copper ferrite can be applied in a magnetic device.

### CROSS-REFERENCE TO RELATED APPLICATIONS

This application is a continuation of international patent application No. PCT/CN2023/122533, filed on Sep. 28, 2023, which itself claims priority to Chinese patent application No. 202211594105.5, filed on Dec. 13, 2022, and titled “NICKEL-MAGNESIUM-ZINC-COPPER FERRITE AND PREPARATION THEREFOR AND USE THEREOF”. The contents of the above identified applications are hereby incorporated herein in their entireties by reference.

### TECHNICAL FIELD

The present disclosure relates to the field of soft magnetic ferrite technology, and in particular, to a nickel-magnesium-zinc-copper ferrite, a preparation method thereof and a magnetic device thereof.

### BACKGROUND

Soft ferrite magnetic materials mainly include polycrystalline ferrite of spinel, garnet, and magnetite types and single crystal ferrite materials. Due to their high resistivity, low loss, and excellent dielectric properties and frequency characteristics, they are important magnetic functional materials with wide applications in modern medical, communication, military, intelligent electronics, information, photovoltaic, energy storage, automotive electronics, and other fields. Among the soft ferrite magnetic materials of spinel type, nickel zinc ferrite material has become a widely used soft ferrite material in the high-frequency range (1 MHz to 100 MHz) due to its performance characteristics of wide bandwidth and high magnetic permeability.

However, in related technology, in the nickel zinc ferrite with a wide bandwidth and high magnetic permeability, the account of NiO is greater than 15 mol %. The high price of nickel raw materials in the market has led to higher costs and decreased market competitiveness for nickel zinc ferrite products made from the nickel zinc materials. The nickel zinc ferrite materials have performance advantages of wide bandwidth and high magnetic permeability, when magnetic permeability of the nickel zinc ferrite is greater than 900 H/m, Curie temperature of the nickel zinc ferrite materials usually does not reach 110° C. Therefore, in a process of use, traditional nickel zinc ferrite materials cannot meet requirements of high Curie temperature in fields such as automotive electronics, network communication, aerospace and so on. For the traditional nickel zinc ferrite materials, it is difficult to achieve both high Curie temperature and high impedance performance effects on a basis of wide bandwidth and high magnetic permeability.

### SUMMARY

Based on this, it is necessary to provide a nickel-magnesium-zinc-copper ferrite, a preparation method therefor and a use thereof to address the above issues. The nickel-magnesium-zinc-copper ferrite not only maintains a wide frequency and high magnetic permeability, but also has high Curie temperature and high impedance, and the product cost is low, which can meet the market demand for magnetic devices.

The nickel-magnesium-zinc-copper ferrite includes major components and auxiliary additives. By mass fraction, the major components include 66.95% to 71.8% of Fe₂O₃, 15.6% to 19.7% of ZnO, 2.1% to 4.2% of NiO, 2.1% to 5.0% of MnO, 2.0% to 4.9% of CuO and 1.82% to 2.98% of MgO. By mass fraction, the auxiliary additives include CaCO₃, Bi₂O₃, MoO₃ and Co₂O₃. A mass of CaCO₃ ranges from 0.1% to 0.3% of that of the major components. A mass of Bi₂O₃ ranges from 0.1% to 0.4% of that of the major components. A mass of MoO₃ ranges from 0.01% to 0.39% of that of the major components. A mass of Co₂O₃ ranges from 0.01% to 0.29% of that of the major components.

In an embodiment, the major components include, by mass fraction, 68.2% to 70.9% of Fe₂O₃, 16.1% to 19.1% of ZnO, 2.2% to 3.5% of NiO, 2.7% to 5.0% of MnO, 3.5% to 4.9% of CuO, and 1.95% to 2.35% of MgO.

In an embodiment, a mass of CaCO₃ ranges from 0.15% to 0.3% of that of the major components. In an embodiment, a mass of Bi₂O₃ ranges from 0.1% to 0.3% of that of the major components. In an embodiment, a mass of MoO₃ ranges from 0.05% to 0.3% of that of the major components. In an embodiment, a mass of Co₂O₃ ranges from 0.01% to 0.2% of that of the major components.

A method for preparing the nickel-magnesium-zinc-copper ferrite includes following steps: weighing the major components according to proportion and wet-grinding same to obtain a first mixture; drying and pre-sintering the first mixture to obtain a pre-sintered material; weighing the auxiliary additives according to proportion, wet-grinding the auxiliary additives with the pre-sintered material and drying same to obtain a second mixture; and, powdering, shaping, and sintering the second mixture in sequence to obtain nickel-magnesium-zinc-copper ferrite.

In an embodiment, in the step of weighing the major components and wet-grinding, a weight ratio of the major components, a grinding ball, and a solvent is 1:(4.5 to 6):(0.6 to 1.2).

In an embodiment, in the step of weighing the auxiliary additives according proportion and wet-grinding the auxiliary additives with the pre-sintered material, a weight ratio of a sum of the auxiliary additives and the pre-sintered material, a grinding ball, and a solvent is 1:(4 to 7):(1 to 1.2).

In an embodiment, a particle size of the second mixture is in a range of 0.5 μm to 1.6 μm.

In an embodiment, the step of sintering is a segmented heating sintering process.

In an embodiment, in the step of shaping, pressure of shaping is in a range of 3 MPa to 10 MPa.

The present disclosure further provides a magnetic device including the nickel-magnesium-zinc-copper ferrite.

Details of one or more embodiments of this application are presented in the attached drawings and descriptions below. And other features, purposes and advantages of this application will become apparent from the description, drawings and claims.

### DETAILED DESCRIPTION

The following will provide a clear and complete description of the technical solution in the embodiments of the present disclosure, in communication with the accompanying drawings. Obviously, the described embodiments are only a part of the embodiments of the present disclosure, not all of them. Based on the embodiments in the present disclosure, all other embodiments obtained by ordinary skill in this art without creative labor fall within the scope of protection of the present disclosure.

In order to facilitate understanding of the present disclosure, a more detailed description of the present disclosure will be provided below. However, it should be understood that the present disclosure can be implemented in many different forms and is not limited to the embodiments or examples described herein. On the contrary, the purpose of providing these embodiments or examples is to make the understanding of the disclosed content of the present disclosure more thorough and comprehensive.

Unless otherwise defined, all technical and scientific terms used in this article have the same meanings as those commonly understood by those skilled in the art of the present disclosure. The terms used in the specification of the present disclosure are only for the purpose of describing specific embodiments and are not intended to limit the present disclosure. The term “and/or” used in this article includes any and all combinations of one or more related listed items.

The present disclosure provides a nickel-magnesium-zinc-copper ferrite. The nickel-magnesium-zinc-copper ferrite includes major components and auxiliary additives. By mass fraction, the major components include 66.95% to 71.8% of Fe₂O₃, 15.6% to 19.7% of ZnO, 2.1% to 4.2% of NiO, 2.1% to 5.0% of MnO, 2.0% to 4.9% of CuO and 1.82% to 2.98% of MgO. By mass fraction, the auxiliary additives include CaCO₃, Bi₂O₃, MoO₃ and Co₂O₃, a mass of CaCO₃ ranges from 0.1% to 0.3% of that of the major component, a mass of Bi₂O₃ ranges from 0.1% to 0.4% of that of the major component, a mass of MoO₃ ranges from 0.01% to 0.39% of that of the major component, and a mass of Co₂O₃ ranges from 0.01% to 0.29% of that of the major component.

In the nickel-magnesium-zinc-copper ferrite of the present disclosure, an account of NiO is reduced, which is cooperated with Fe₂O₃, ZnO, MgO, MnO, and CuO, with specific amounts and CaCO₃, Bi₂O₃, MoO₃, and Co₂O₃ with specific proportions are added as the auxiliary additives, facilitating improving a microstructure of nickel-magnesium-zinc-copper ferrite. That is, the nickel-magnesium-zinc-copper ferrite is densified, and a spinel lattice structure of the nickel-magnesium-zinc-copper ferrite is maintained, resulting in avoiding lattice distortion, thus the nickel-magnesium-zinc-copper ferrite maintains a high permeability over a wide frequency range from 1 kHz to 1000 KHz, while having a high Curie temperature of at least 160° C. and high impedance, and a product cost is greatly reduced.

In order to further adjust magnetic permeability and Curie temperature, the account of Fe₂O₃ is slightly excessed, and Zn in ZnO can be inhibited to volatilize by cooperation between Fe₂O₃, ZnO, MgO, MnO, and CuO. In some embodiment, the major components include, by the mass fraction, 68.2% to 70.9% Fe₂O₃, 16.1% to 19.1% of ZnO, 2.2% to 3.5% of NiO, 2.7% to 5.0% of MnO, 3.5% to 4.9% of CuO, and 1.95% to 2.35% of MgO.

A composition of CaCO₃, Bi₂O₃, MoO₃, and Co₂O₃ is the auxiliary additives, which is cooperated with Fe₂O₃, ZnO, MgO, MnO, and CuO of the major components, resulting in stability improving an electromagnetic property of nickel-magnesium-zinc-copper ferrite.

By further precisely adjusting of proportion between CaCO₃, Bi₂O₃, MoO₃, and Co₂O₃, it facilitates obtaining nickel-magnesium-zinc-copper ferrite with better performance.

The account of CaCO₃ can be adjusted slightly to further improve a solid-phase reaction, facilitating further making the nickel-magnesium-zinc-copper ferrite densify, resulting in increasing the density of the nickel-magnesium-zinc-copper ferrite, and facilitating synergistically adjusting grain size of the nickel-magnesium-zinc-copper ferrite, resulting in improving a performance of the nickel-magnesium-zinc-copper ferrite. In some embodiments, the mass of CaCO₃ ranges from 0.15% to 0.3% of that of the major components.

Bi₂O₃ and MoO₃ with lower melting point can form a liquid phase during a process of preparing the nickel-magnesium-zinc-copper ferrite, facilitating promoting the solid-phase reaction. In the major components with slightly excessive Fe₂O₃, the account of MoO₃ can be slightly adjusted, facilitate further promoting grow of grain of the nickel-magnesium-zinc-copper ferrite, facilitating improving primary magnetic permeability, and synergistically reducing additive amount of Bi₂O₃. In some embodiments, the mass of Bi₂O₃ ranges from 0.1% to 0.3% of that of the major component. In some embodiments, the mass of MoO₃ ranges from 0.05% to 0.3% of that of the major components.

Co₂O₃ can be substituted with the major components and dissolved in the spinel lattice. The account of Co₂O₃ can be slightly adjusted, facilitating further improving micro structure of the nickel-magnesium-zinc-copper ferrite, resulting in improving stop frequency, improving resistivity, reducing losses, enhancing high-frequency impedance performance, and maintaining magnetic permeability. In some embodiments, the mass of Co₂O₃ ranges from 0.01% to 0.2% of that of the major components.

In some embodiments, in the nickel-magnesium-zinc-copper ferrite, the major components include, by the mass fraction, 68.2% to 70.9% of Fe₂O₃, 16.1% to 19.1% of ZnO, from 2.2% to 3.5% of NiO, 2.7% to 5.0% of MnO, 3.5% to 4.9% of CuO and 1.95% to 2.35% of MgO. The auxiliary additives include CaCO₃, Bi₂O₃, MoO₃ and Co₂O₃, the mass of CaCO₃ ranges from 0.15% to 0.3% of that of the major component, the mass of Bi₂O₃ ranges from 0.1% to 0.3% of that of the major component, the mass of MoO₃ ranges from 0.05% to 0.3% of that of the major component, and the mass of Co₂O₃ ranges from 0.01% to 0.2% of that of the major component.

The present disclosure further provides a method for preparing the nickel-magnesium-zinc-copper ferrite. The method of preparing the nickel-magnesium-zinc-copper ferrite includes following steps:

S1, weighing the major components according to proportion and wet-grinding same to obtain a first mixture; S2, drying and pre-sintering the first mixture to obtain a pre-sintered material; S3, weighing the auxiliary additives according to the proportion, wet-grinding the auxiliary additives with the pre-sintered material, drying same to obtain a second mixture; and S4, powdering, shaping, and sintering the second mixture in sequence to obtain the nickel-magnesium-zinc-copper ferrite.

In the step S1, in order to adjust moisture content of the first mixture, the first mixture is mixed evenly, and breathability of the first mixture is improved, thereby improving sintering efficiency of the nickel-magnesium-zinc-copper ferrite. In the step of weighing the major component according to the proportion and wet-grinding, a weight ratio of the major component, a grinding ball, and a solvent is 1:(4.5 to 6):(0.6 to 1.2). In some embodiments, the solvent is water.

In order to evenly mix the major component and the solvent, in some embodiments, time of a wet-grinding process is in a range of 1 h to 3 h.

In the step S2, an influence of the solvent in the first mixture for sintering technology can be reduced by drying. By a pre-sintering process, a microstructure of nickel-magnesium-zinc-copper ferrite is improved, so as to ensure a volume stability of the nickel-magnesium-zinc-copper ferrite and accuracy of external dimensions of the nickel-magnesium-zinc-copper ferrite, resulting in improving the performance of the nickel-magnesium-zinc-copper ferrite.

The temperature of the step of pre-sintering is in a range of 920° C. to 1000° C., and the time of the step of pre-sintering is in a range of 6 h to 10 h.

In the step S3, in order to achieve a suitable particle size distribution, good flowability, and a certain loose packing density for the second mixture, it benefits for subsequent powdering and shaping, so as to obtain the nickel-magnesium-zinc-copper ferrite with high quality. In addition, in the step of weighing the auxiliary additives according the proportion and wet-grinding the auxiliary additives with the pre-sintering material, a weight ratio of a sum of the auxiliary additive and the pre-sintering material, the grinding ball, and a solvent is 1:(4 to 7):(1 to 1.2). In some embodiments, the time of the wet-grinding process is in a range of 2 h to 6 h.

Furthermore, considering efficiency of a subsequent powdering process, in some embodiments, a particle size of the second mixture is in a range of 0.5 μm to 1.6 μm.

In the step S4, the second mixture is selected by the powdering process, granulated powder with uniform particle size and good activity is prepared, thereby ensuring the granulated power to distribute more evenly during a process of shaping, and ensuring consistency and density of a formed billet.

In order to further ensure a compression performance and billet strength in the shaping process, in some embodiments, the powdering technology is a spraying powdering method.

A preparing step of the spraying powdering includes: mixing binder, defoamer and the second mixture for 1 h to 3 h, and obtaining the granulated powder via a spraying powdering process. The mass of the binder ranges from 5% to 15% of the mass of the second mixture. The mass of the defoamer ranges from 0.03% to 0.3% of the mass of the second mixture. In some embodiments, the binder is a polyvinyl alcohol solution with 8% to 10% concentration. In some embodiments, the defoamer is capryl alcohol.

In order to facilitate demolding of a shaped billet, in some embodiments, a lubricant is added to the granulated powder, which is mixed and pressed into the billet. The mass of the lubricant ranges from 0.01% to 0.1% of the mass of granulated powder. In some embodiments, the lubricant is zinc stearate.

In an embodiment, a pressure of shaping process is in a range of 3 MPa to 10 MPa.

The step of sintering can be a once heating sintering process or a segmented heating sintering process. In some embodiments, the step of sintering is the segmented heating sintering process. In some embodiments, the segmented heating sintering process includes a first heating stage, a second heating stage, an insulation stage, a temperature-reducing stage, and a cooling process. The temperature of the first heating stage is in a range of 800° C. to 1000° C., and the time of the first heating stage is in a range of 5 h to 10 h. The temperature of the second heating stage is in a range of 1180° C. to 1220° C., and the time of the second heating stage is in a range of 1.5 h to 3 h. The temperature of the insulation stage is the same as the temperature of the second heating stage, and the time of the insulation stage is in a range of 3 h to 6 h. The temperature of the temperature-reducing stage is in a range of 130° C. to 200° C., and the time of the temperature-reducing stage is in a range of 7 h to 10 h. The cooling process is cooling the sintered billet into a room temperature.

The present disclosure further provides a use of the nickel magnesium zinc copper ferrite in a magnetic device.

The nickel-magnesium-zinc-copper ferrite is used in the magnetic device, which can satisfy a performance requirement of broadband high impedance, high Curie temperature and so on, for the nickel-magnesium-zinc-copper ferrite in fields such as modern medical, automotive, photovoltaic, network communication, aerospace and so on. Therefore, a market requirement for the nickel-magnesium-zinc-copper ferrite in applications such as inductive filters, photovoltaic energy storage transformers, and medical devices further increases. In addition, the nickel-magnesium-zinc-copper ferrite can significantly reduce a production cost, thereby increasing a market competitiveness of the nickel-magnesium-zinc-copper ferrite in the magnetic device.

In the following, the nickel-magnesium-zinc-copper ferrite, the method thereof and the use thereof are further described by the following specific embodiments.

### Example 1

68.6 weight percent of Fe₂O₃, 18.65 weight percent of ZnO, 3.4 weight percent of NiO, 2.7 weight percent of MnO, 4.6 weight percent of CuO and 2.05 weight percent of MgO were weighed to form major components. The major components, a grinding ball, and water were mixed and wet-grinded for 1 h to obtain a first mixture, in which a weight ratio of the major components, the grinding ball, and the water was 1:4.5:0.8.

The first mixture was dried and pre-sintered at 950° C. for 6 h, and insulated for 4 hours to obtain a pre-sintered material.

CaCO₃, Bi₂O₃, MoO₃ and Co₂O₃ were weighed as auxiliary additives, in which the mass of CaCO₃ was 0.15% of that of the major components, the mass of Bi₂O₃ is 0.15% of that of the major components, the mass of MoO₃ was 0.08% of that of the major components, and the mass of Co₂O₃ was 0.05% of that of the major components. A pre-sintered material with the auxiliary additive, a grinding ball and water were mixed and wet-grinded in a weight ratio of 1:4:1 for 3 hours, which was dried to obtain a second mixture with an average particle size of 1.2 μm.

Polyvinyl alcohol solution (mass fraction thereof is 5%) and n-capryl alcohol were added to the second mixture, which was stirred for 2 hours to obtain a granulated power. The mass of the polyvinyl alcohol solution was 5% of that of the second mixture. The mass of the n-capryl alcohol was 0.1% of that of the second mixture. Zinc stearate was added to the granulated powder, which was stirred evenly and pressed into a billet under a pressure of shaping of 5 MPa. An additive amount of the zinc stearate was 0.1% of the mass of the granulated power. The billet was placed into push plate kiln for segmented heating sintering, which includes following steps: the temperature of the billet was increased from a room temperature to 900° C. within 8 hours, the temperature was continuously increased at 1205° C. within 2 hours and insulated for 3 hours, the temperature was reduced to 150° C. within 10 hours, the billet was cooled to the room temperature, and a ring-shaped nickel-magnesium-zinc-copper ferrite with an outer size of 25 mm, an inner size of 15 mm and a height of 7 mm was obtained.

### Example 2

70.1 weight percent of Fe₂O₃, 16.65 weight percent of ZnO, 2.8 weight percent of NiO, 3.5 weight percent of MnO, 4.6 weight percent of CuO and 2.35 weight percent of MgO were weighed to form major components. The major components, a grinding ball, and water were mixed and wet-grinded for 1 hour to obtain a first mixture, in which a weight ratio of the major components, the grinding ball, and the water was 1:5:1.2.

The first mixture was dried and pre-sintered at 980° C. for 8 hours, and insulated for 4 hours to obtain a pre-sintered material.

CaCO₃, Bi₂O₃, MoO₃ and Co₂O₃ were weighed as auxiliary additives, in which the mass of CaCO₃ was 0.15% of that of the major components, the mass of Bi₂O₃ was 0.15% of that of the major components, the mass of MoO₃ was from to 0.1% of that of the major components, and the mass of Co₂O₃ was from 0.05% of that of the major components. A pre-sintered material with the auxiliary additive, a grinding ball and water were mixed and wet-grinded in a weight ratio of 1:5:1.2 for 4 hours, which was dried to obtain a second mixture with an average particle size of 1.1 μm.

Polyvinyl alcohol solution (mass fraction thereof is 10%) and n-capryl alcohol were added to the second mixture, which was quickly stirred for 2 hours to obtain a granulated power. The mass of the polyvinyl alcohol solution was 10% of that of the second mixture. The mass of the n-capryl alcohol was 0.1% of that of the second mixture. Zinc stearate was added to the granulated powder, which was stirred evenly and pressed into a billet under a pressure of shaping of 5 MPa. An additive amount of the zinc stearate was 0.1% of the mass of the granulated power. The billet was placed into a push plate kiln for segmented heating sintering, which includes following steps: the temperature of the billet was increased from a room temperature to 900° C. within 8 hours, the temperature was continuously increased at 1205° C. within 2 hours and insulated for 3 hours, the temperature was reduced to 150° C. within 10 hours, the billet was cooled into the room temperature, and a ring-shaped nickel-magnesium-zinc-copper ferrite with an outer size of 25 mm, an inner size of 15 mm and height of 7 mm was obtained.

### Example 3

69.5 weight percent of Fe₂O₃, 16.1 weight percent of ZnO, 2.2 weight percent of NiO, 4.6 weight percent of MnO, 4.75 weight percent of CuO and 2.85 weight percent of MgO were weighed to form major components. The major components, a grinding ball, and water were mixed and wet-grinded for 1 hour to obtain a first mixture, in which a weight ratio of the major components, the grinding ball, and the water was 1:5:1.2.

The first mixture was dried and pre-sintered at 980° C. for 8 hours, and insulated for 4 hours to obtain a pre-sintered material.

CaCO₃, Bi₂O₃, MoO₃ and Co₂O₃ were weighed as auxiliary additives, in which the mass of CaCO₃ was 0.2% of that of the major components, the mass of Bi₂O₃ was 0.15% of that of the major components, the mass of MoO₃ was 0.15% of that of the major components, and the mass of Co₂O₃ was 0.1% of that of the major components. A pre-sintered material with the auxiliary additive, a grinding ball and water were mixed and wet-grinded in a weight ratio of 1:5:1.2 for 4 hours, which was dried to obtain a second mixture with an average particle size of 1.1 μm.

Polyvinyl alcohol solution (mass fraction thereof is 7%) and n-capryl alcohol were added to the second mixture, which was quickly stirred for 2 hours to obtain a granulated power. The mass of the polyvinyl alcohol solution was 10% of that of the second mixture. The mass of the capryl alcohol was 0.12% of that of the second mixture. Zinc stearate was added to the granulated powder, which was stirred evenly and pressed into a billet under a pressure of shaping of 5.5 MPa. An additive amount of the zinc stearate was 0.2% of the mass of the granulated power. The billet was placed into push plate kiln for segmented heating sintering, which includes following steps: the temperature of the billet was increased from a room temperature to 920° C. within 9 hours, the temperature was continuously increased at 1190° C. within 3 hours and insulated for 2 hours, the temperature was reduced to 150° C. within 10 hours, the billet was cooled into the room temperature, and a ring-shaped nickel-magnesium-zinc-copper ferrite with an outer size of 25 mm, an inner size of 15 mm and height of 7 mm was obtained.

### Example 4

68.6 weight percent of Fe₂O₃, 17.65 weight percent of ZnO, 3.1 weight percent of NiO, 3.7 weight percent of MnO, 4.6 weight percent of CuO and 2.35 weight percent of MgO were weighed to form major components. The major components, a grinding ball, and water were mixed and wet-grinded for 1 hour to obtain a first mixture, in which a weight ratio of the major components, the grinding ball, and the water was 1:5:1.2.

The first mixture was dried and pre-sintered at 980° C. for 8 hours, and insulated for 4 hours to obtain a pre-sintered material.

CaCO₃, Bi₂O₃, MoO₃ and Co₂O₃ were weighed as auxiliary additives, in which the mass of CaCO₃ was 0.15% of that of the major components, the mass of Bi₂O₃ was 0.1% of that of the major components, the mass of MoO₃ was 0.2% of that of the major components, and the mass of Co₂O₃ was 0.2% of that of the major component, a pre-sintered material with the auxiliary additive, a grinding ball and water were mixed and wet-grinded in a weight ratio of 1:5:1.2 for 4 hours, which was dried to obtain a second mixture with an average particle size of 1.1 μm.

Polyvinyl alcohol solution (mass fraction thereof is 10%) and n-capryl alcohol were added to the second mixture, which was quickly stirred for 3 hours to obtain a granulated power. The mass of the polyvinyl alcohol solution was 10% of that of the second mixture. The mass of the capryl alcohol was 0.1% of that of the second mixture. Zinc stearate was added to the granulated powder, which was stirred evenly and pressed into a billet under a pressure of shaping of 5 MPa. An additive amount of the zinc stearate was 0.1% of the mass of the granulated power. The billet was placed into push plate kiln for segmented heating sintering, which includes following steps: the temperature of the billet was increased from a room temperature to 950° C. within 6 hours, the temperature was continuously increased at 1195° C. within 2 hours and insulated for 3 hours, the temperature was reduced to 150° C. within 10 hours, the billet was cooled into the room temperature, and a ring-shaped nickel-magnesium-zinc-copper ferrite with an outer size of 25 mm, an inner size of 15 mm and height of 7 mm was obtained.

### Comparative Example 1

The comparative example 1 is substantially the same as the example 1, except that, in the comparative example 1, no auxiliary additive was added, pre-sintered material directly was dry-grinded until an average particle size of the pre-sintered material is 1.1 μm, powdering, shaping, and sintering was processed.

### Comparative Example 2

The comparative example 2 is substantially the same as the example 2, except that, in the comparative example 2, in an auxiliary additive, a mass of Co₂O₃ is 0.4% of that of major components.

### Comparative Example 3

The comparative example 3 is substantially the same as the example 3, except that, in the comparative example 3, in an auxiliary additive, the mass of MoO₃ is 0.4% of that of a major component.

### Comparative Example 4

The comparative example 4 is substantially the same as the example 4, except that, in the comparative example 4, in an auxiliary additive, a mass of CaCO₃ was 0.4% of that of major components.

### Comparative Example 5

The comparative example 5 is substantially the same as the example 4, except that, in the comparative example 5, Co₂O₃ was not added in auxiliary additives.

### Comparative Example 6

The comparative example 6 is substantially the same as the example 4, except that, in the comparative example 6, no MoO₃ was added in auxiliary additives.

### Comparative Example 7

The comparative example 7 is substantially the same as the example 4, except that, in the comparative example 7, CaCO₃ was not added in auxiliary additives.

### Comparative Example 8

The comparative example 8 is substantially the same as the example 4, except that, in the comparative example 8, in major components, Fe₂O₃ was 64.91 weight percent, ZnO was 19.37 weight percent, NiO was 3.1 weight percent, MnO was 4.2 weight percent, CuO was 6.37 weight percent and MgO is 2.05 weight percent.

### Comparative Example 9

The comparative example 9 is substantially the same as the example 4, except that, in the comparative example 9, in major components, ZnO was 20 weight percent and Fe₂O₃ was 70.95 weight percent.

### Comparative Example 10

The comparative example 10 is substantially the same as the example 4, except that, in the comparative example 10, in major components, MnO was 1.2 weight percent and Fe₂O₃ was 71.1 weight percent.

### Comparative Example 11

The comparative example 11 is substantially the same as the example 4, except that, in the comparative example 11, in major components, Fe₂O₃ was 70.6 weight percent, ZnO was 17.65 weight percent, NiO was 3.45 weight percent, MnO was 3.7 weight percent and CuO was 4.6 weight percent.

The magnets obtained from the examples 1 to 4 and the comparative example 1 to 11 were tested for the quality. The result was shown in Table 1.

In a condition of temperature (T) is 25° C. and voltage (u) is 0.25 v, AgClient E4980A was used to test the primary magnetic permeability (μi) under frequency conditions of 1 KHz, 100 KHz, 200 KHz, and 1000 KHz and high-low-temperature-controllable oven was used to test Curie temperature (Tc). SM-8220 testing instrument was used for testing surface resistance. Impedance testing was conducted by HP4291B at frequencies of 1 MHz, 25 MHz, 100 MHz, and 200 MHz.

TABLE 1

| | | | Primary magnetic permeability | | | | | | | |
|---|---|---|---|---|---|---|---|---|---|---|
| | Curie | Surface | of different frequencies (μᵢ) | | | | Impedance (Ω) | | | |
| | temperature | resistance | 1K | 100K | 200K | 1000K | 1M | 25M | 100M | 200M |
| | (° C.) | (Ω · m) | Hz | Hz | Hz | Hz | Hz | Hz | Hz | Hz |
| Example 1 | 165 | 1.2 × 10⁷ | 1045 | 1022 | 1016 | 1012 | 11.01 | 74.51 | 179 | 389 |
| Example 2 | 177 | 4.8 × 10⁷ | 1240 | 1185 | 1152 | 1072 | 11.91 | 75.8 | 176 | 381 |
| Example 3 | 165 | 3.2 × 10⁷ | 993 | 975 | 962 | 932 | 11.12 | 76.4 | 181 | 393 |
| Example 4 | 180 | 5.2 × 10⁷ | 1092 | 1026 | 1004 | 942 | 10.86 | 79.1 | 192 | 401 |
| Comparative | 120 | 4.1 × 10⁷ | 1290 | 1023 | 984 | 876 | 12.45 | 74.6 | 169 | 366 |
| example 1 | | | | | | | | | | |
| Comparative | 260 | 4.2 × 10⁷ | 285 | 259 | 256 | 261 | 3.65 | 81.3 | 212 | 448 |
| example 2 | | | | | | | | | | |
| Comparative | 105 | 6.5 × 10⁷ | 790 | 743 | 675 | 612 | 8.76 | 71.9 | 161 | 375 |
| example 3 | | | | | | | | | | |
| Comparative | 137 | 8.1 × 10⁷ | 852 | 841 | 817 | 804 | 9.28 | 73.4 | 165 | 381 |
| example 4 | | | | | | | | | | |
| Comparative | 110 | 6.3 × 10⁵ | 1490 | 1380 | 1260 | 1030 | 15.61 | 69.2 | 146 | 246 |
| example 5 | | | | | | | | | | |
| Comparative | 160 | 7.6 × 10⁷ | 569 | 557 | 549 | 541 | 7.28 | 78.7 | 187 | 382 |
| example 6 | | | | | | | | | | |
| Comparative | 148 | 3.6 × 10⁵ | 921 | 916 | 908 | 902 | 9.76 | 75.2 | 172 | 374 |
| example 7 | | | | | | | | | | |
| Comparative | 155 | 3.2 × 10³ | 522 | 510 | 507 | 496 | 6.54 | 78.7 | 196 | 412 |
| example 8 | | | | | | | | | | |
| Comparative | 90 | 2.1 × 10⁶ | 1153 | 1047 | 986 | 725 | 11.51 | 67.6 | 141 | 195 |
| example 9 | | | | | | | | | | |
| Comparative | 142 | 2.9 × 10⁵ | 905 | 864 | 812 | 734 | 9.34 | 65.5 | 170 | 351 |
| example 10 | | | | | | | | | | |
| Comparative | 167 | 5.2 × 10⁷ | 812 | 809 | 802 | 792 | 8.95 | 79.9 | 189 | 387 |
| example 11 | | | | | | | | | | |

According to the table 1, in the nickel-magnesium-zinc-copper ferrite, an account of NiO was reduced, which was cooperated with specific amounts of Fe₂O₃, ZnO, MgO, MnO, and CuO, and specific proportions of CaCO₃, Bi₂O₃, MoO₃, and Co₂O₃ were added as the auxiliary additives, such that the nickel-magnesium-zinc-copper ferrite could maintain a high permeability over a wide frequency range of 1 KHz to 1000 KHz, and have a high Curie temperature of at least 160° C. and high impedance of at least 105 Ω·m (DC 500 V, distance 10 mm).

Since the comparative example 1 had no auxiliary additive to coordinate to a major component, the Curie temperature was reduced to 120° C. In the comparative example 2, the account of Co₂O₃ excessed 0.29%, causing lattice distortion and resulting in a decrease in the primary magnetic permeability. In the comparative example 3, the account of MoO₃ excessed 0.39%, causing discontinuous growth of some grains, increasing grain boundary stress, and increasing porosity, and resulting in a decrease in density, the magnetic permeability, and the Curie temperature. In the comparative example 4, the account of CaCO₃ excessed 0.3%, resulting in a significant decrease in magnetic performance. In the comparative example 5, Co₂O₃ was not added, resulting in increased losses, decreased resistivity, and decreased high-frequency impedance performance. In the comparative 6, MoO₃ was not added, resulting in a decrease in initial magnetic permeability. In the comparative example 7, CaCO₃ was not added, resulting in a decrease in density and a significant decrease in magnetic properties. In the comparative example 8, the account of Fe₂O₃ was less than 68.2 weight percent and the account of CuO was greater than 4.9 weight percent, resulting in an increase in zinc volatilization and causing a phenomenon of “zinc removal”, thereby reducing electrical resistivity and magnetic permeability. In the comparative example 9, the account of ZnO was greater than 19.7 weight percent, resulting in a decrease in Curie temperature. The account of MnO in comparative example 10 is less than 2.1 weight percent, resulting in a decrease in the magnetic permeability and the Curie temperature. In the comparative example 11, MgO was not added, resulting in a decrease in the magnetic permeability.

### Example 5

The example 5 is substantially the same as the example 2, except that, in the comparative example 5, in major components, Fe₂O₃ was 66.96 weight percent, ZnO was 19.7 weight percent, NiO was 4.12 weight percent, MnO was 4.3 weight percent, CuO was 3.1 weight percent and MgO was 1.82 weight percent.

### Example 6

The example 6 is substantially the same as the example 2, except that, in the example 6, in major components, Fe₂O₃ was 71.8 weight percent, ZnO was 15.6 weight percent, NiO was 3.5 weight percent, MnO was 4.12 weight percent, CuO was 2 weight percent and MgO was 2.98 weight percent.

### Example 7

The example 7 is substantially the same as the example 2, except that, in the example 7, in major components, Fe₂O₃ was 70.9 weight percent, ZnO was 17.95 weight percent, NiO was 2.1 weight percent, MnO was 2.1 weight percent, CuO was 4.9 weight percent and MgO was 2.05 weight percent.

### Example 8

The example 8 is substantially the same as the example 2, except that, in the example 8, in major components, Fe₂O₃ was 68.2 weight percent, ZnO was 19.1 weight percent, NiO was 3.25 weight percent, MnO was 4 weight percent, CuO was 3.5 weight percent and MgO was 1.95 weight percent.

The magnets obtained in the examples 5 to 8 were tested for the quality, and the result was shown in table 2.

TABLE 2

| | | | Primary magnetic permeability | | | | | | | |
|---|---|---|---|---|---|---|---|---|---|---|
| | Curie | Surface | in different frequencies (μᵢ) | | | | Impedance (Ω) | | | |
| | temperature | resistance | 1K | 100K | 200K | 1000K | 1M | 25M | 100M | 200M |
| | (° C.) | (Ω · m) | Hz | Hz | Hz | Hz | Hz | Hz | Hz | Hz |
| Example 5 | 160 | 7.9 × 10⁵ | 954 | 948 | 936 | 921 | 10.98 | 70.3 | 173 | 374 |
| Example 6 | 180 | 9.8 × 10⁵ | 1320 | 1165 | 987 | 839 | 12.35 | 72.6 | 169 | 367 |
| Example 7 | 162 | 5.7 × 10⁶ | 1265 | 1241 | 1206 | 1165 | 12.04 | 73.7 | 171 | 372 |
| Example 8 | 165 | 3.2 × 10⁷ | 1105 | 1087 | 1065 | 1032 | 11.03 | 75.1 | 175 | 379 |

Comparing the example 2 with the examples 5 to 8, by mass fraction, when the major components include, by mass fraction, 68.2% to 70.9% of Fe₂O₃, 16.1% to 19.1% of ZnO, 2.2% to 3.5% of NiO, 2.7% to 5% of MnO, 3.5% to 4.9% of CuO and 1.95% to 2.35% of MgO, a performance of nickel-magnesium-zinc-copper ferrite is better.

### Example 9

The example 9 is substantially the same as the example 2, except that, in the example 9, in auxiliary additives, a mass of CaCO₃ was 0.1% of that of major components, a mass of Bi₂O₃ was 0.4% of that of the major components, a mass of MoO₃ is 0.05% of that of the major components, a mass of Co₂O₃ was 0.29% of that of the major components.

### Example 10

The example 10 is substantially the same as the example 2, except that, in the example 10, in auxiliary additives, a mass of CaCO₃ was 0.1% of that of major components, a mass of Bi₂O₃ was 0.1% of that of the major components, a mass of MoO₃ was 0.39% of that of the major components, and a mass of Co₂O₃ was 0.01% of that of the major components.

### Example 11

The example 11 is substantially the same as the example 2, except that, in the example 11, in auxiliary additives, a mass of CaCO₃ was 0.3% of that of major components, a mass of Bi₂O₃ was 0.25% of that of the major components, a mass of MoO₃ was 0.01% of that of the major components, and a mass of Co₂O₃ was 0.15% of that of the major components.

### Example 12

The example 12 is substantially the same as the example 2, except that, in the example 12, in auxiliary additives, a mass of CaCO₃ was 0.1% of that of major components, a mass of Bi₂O₃ is 0.2% of that of the major components, a mass of MoO₃ was 0.3% of that of the major components, a mass of Co₂O₃ was 0.01% of that of the major components.

The magnets obtained in examples 9 to 12 were tested for the quality, and the result was shown in table 3.

TABLE 3

| | | | Primary magnetic permeability | | | | | | | |
|---|---|---|---|---|---|---|---|---|---|---|
| | Curie | Surface | of different frequencies (μᵢ) | | | | Impedance (Ω) | | | |
| | temperature | resistance | 1K | 100K | 200K | 1000K | 1M | 25M | 100M | 200M |
| | (° C.) | (Ω · m) | Hz | Hz | Hz | Hz | Hz | Hz | Hz | Hz |
| Example 9 | 169 | 5.9 × 10⁶ | 1065 | 1047 | 1024 | 1002 | 10.99 | 76.1 | 178 | 387 |
| Example 10 | 171 | 9.8 × 10⁶ | 1354 | 1312 | 1256 | 1181 | 13.02 | 71.2 | 164 | 365 |
| Example 11 | 162 | 5.7 × 10⁶ | 963 | 958 | 941 | 911 | 10.91 | 72.7 | 173 | 375 |
| Example 12 | 167 | 3.2 × 10⁶ | 1280 | 1242 | 1203 | 1126 | 12.87 | 70.4 | 163 | 362 |

Comparing the examples 9 to 12 with the example 2, when the auxiliary additives include CaCO₃, Bi₂O₃, MoO₃ and Co₂O₃, a mass of CaCO₃ ranges from 0.15% to 0.3% of that of the major components, a mass of Bi₂O₃ ranges from 0.1% to 0.3% of that of the major components, a mass of MoO₃ ranges from 0.05% to 0.3% of that of the major components, and a mass of Co₂O₃ ranges from 0.01% to 0.2% of that of the major components, and the performance of the nickel-magnesium-zinc-copper ferrite is better.

Furthermore, comparing the examples 5 to 12 with the comparative examples 1, 2 and 4, the major components include, by the mass fraction, 68.2% to 70.9% of Fe₂O₃, 16.1% to 19.1% of ZnO, 2.2% to 3.5% of NiO, 2.7% to 5.0% of MnO, 3.5% to 4.9% of CuO and 1.95% to 2.35% of MgO, and the auxiliary additives include CaCO₃, Bi₂O₃, MoO₃ and Co₂O₃, the mass of CaCO₃ ranges from 0.15% to 0.3% of that of the major components, the mass of Bi₂O₃ ranges from 0.1% to 0.3% of that of the major components, the mass of MoO₃ ranges from 0.05% to 0.3% of that of the major components, and the mass of Co₂O₃ ranges from 0.01% to 0.2% of that of the major components, the performance of the nickel-magnesium-zinc-copper ferrite is best.

In the nickel-magnesium-zinc-copper ferrite of the present disclosure, the account of NiO was reduced, which cooperates with specific amounts of Fe₂O₃, ZnO, MgO, MnO, and CuO, and specific proportions of CaCO₃, Bi₂O₃, MoO₃, and Co₂O₃ were added as the auxiliary additives, facilitating improving a microstructure of nickel-magnesium-zinc-copper ferrite. Moreover, the nickel-magnesium-zinc-copper ferrite is densified, and a spinel lattice structure of the nickel-magnesium-zinc-copper ferrite is maintained, resulting in avoiding lattice distortion, thus the nickel-magnesium-zinc-copper ferrite maintains the high permeability over the wide frequency in a range from 1 KHz to 1000 KHz, while having the high Curie temperature of at least 160° C. and the high impedance, and a product cost is significantly reduced.

Therefore, the nickel-magnesium-zinc-copper ferrite can meet broadband high impedance, high Curie temperature and other performance requirements in fields of modern medical, automotive, photovoltaic, network communication, aerospace and other fields. It not only improves market demand of nickel-magnesium-zinc-copper ferrite in inductive filters, photovoltaic energy storage transformers, medical devices and other application fields, but also further enhances market competitiveness of the nickel-magnesium-zinc-copper ferrite.

The various technical features of the above embodiments can be combined in any way. In order to make the description concise, not all possible combinations of the various technical features in the above embodiments have been described. However, as long as there is no contradiction in the combination of these technical features, they should be considered within the scope of the specification.

The above embodiments only express several embodiments of the present disclosure, and their descriptions are more specific and detailed, but should not be understood as limiting the scope of the disclosure. It should be pointed out that for ordinary skill in the art, several modifications and improvements can be made without departing from the concept of the disclosure, which are within the scope of protection of the disclosure. Therefore, the scope of protection of the present disclosure should be based on the attached claims.

What is claimed is:

1. A nickel-magnesium-zinc-copper ferrite, comprising:
major components, wherein by mass fraction, the major components comprise 66.95% to 71.8% of Fe₂O₃, 15.6% to 19.7% of ZnO, 2.1% to 4.2% of NiO, 2.1% to 5.0% of MnO, 2.0% to 4.9% of CuO and 1.82% to 2.98% of MgO; and
auxiliary additives, wherein by mass fraction, the auxiliary additives comprise CaCO₃, Bi₂O₃, MoO₃ and Co₂O₃, a mass of CaCO₃ ranges from 0.1% to 0.3% of that of the major components, a mass of Bi₂O₃ ranges from 0.1% to 0.4% of that of the major components, a mass of MoO₃ ranges from 0.01% to 0.39% of that of the major components, and a mass of Co₂O₃ ranges from 0.01% to 0.29% of that of the major components.

2. The nickel-magnesium-zinc-copper ferrite of claim 1, wherein the major components comprise, by mass fraction, 68.2% to 70.9% of Fe₂O₃, 16.1% to 19.1% of ZnO, 2.2% to 3.5% of NiO, 2.7% to 5.0% of MnO, 3.5% to 4.9% of CuO, and 1.95% to 2.35% of MgO.

3. The nickel-magnesium-zinc-copper ferrite of claim 1, wherein a mass of CaCO₃ ranges from 0.15% to 0.3% of that of the major components;
and/or, a mass of Bi₂O₃ ranges from 0.1% to 0.3% of that of the major components;
and/or, a mass of MoO₃ ranges from 0.05% to 0.3% of that of the major components;
and/or, a mass of Co₂O₃ ranges from 0.01% to 0.2% of that of the major components.

4. A method for preparing nickel-magnesium-zinc-copper ferrite of claim 1, comprising following steps:
weighing the major components according to proportion and wet-grinding same to obtain a first mixture;
drying and pre-sintering the first mixture to obtain a pre-sintered material;
weighing the auxiliary additives according to proportion, wet-grinding the auxiliary additives with the pre-sintered material and drying same to obtain a second mixture; and,
powdering, shaping, and sintering the second mixture in sequence to obtain nickel-magnesium-zinc-copper ferrite.

5. The method for preparing the nickel-magnesium-zinc-copper ferrite of claim 4, wherein in the step of weighing the major components and wet-grinding, a weight ratio of the major components, a grinding ball, and a solvent is 1:(4.5 to 6):(0.6 to 1.2).

6. The method for preparing the nickel-magnesium-zinc-copper ferrite of claim 4, wherein in the step of weighing the auxiliary additives according proportion and wet-grinding the auxiliary additives with the pre-sintered material, a weight ratio of a sum of the auxiliary additives and the pre-sintered material, a grinding ball, and a solvent is 1:(4 to 7):(1 to 1.2).

7. The method for preparing the nickel-magnesium-zinc-copper ferrite of claim 4, wherein a particle size of the second mixture is in a range of 0.5 μm to 1.6 μm.

8. The method for preparing the nickel-magnesium-zinc-copper ferrite of claim 4, wherein the step of sintering is a segmented heating sintering process.

9. The method for preparing the nickel-magnesium-zinc-copper ferrite of claim 4, wherein in the step of shaping, pressure of shaping is in a range of 3 MPa to 10 MPa.

10. A magnetic device, comprising the nickel-magnesium-zinc-copper ferrite of claim 1.
